(19) United States
(12) Patent Application Publication
(10) Pub. No.: US 2024/0318051 A1
(43) Pub. Date: Sep. 26, 2024

(54) AQUEOUS PRESSURE-SENSITIVE ADHESIVE COMPOSITION FOR RECYCLING-COMPATIBLE PRESSURE-SENSITIVE ADHESIVE LABELS

(71) Applicant: BASF SE, Ludwigshafen am Rhein (DE)

(72) Inventors: Paul ACHATZ, Ludwigshafen am Rhein (DE); Tina MARK, Ludwigshafen am Rhein (DE); Andree DRAGON, Ludwigshafen am Rhein (DE)

(21) Appl. No.: 18/578,033

(22) PCT Filed: Jul. 6, 2022
(86) PCT No.: PCT/EP2022/068743

§ 371 Date: Jan. 10, 2024

(30) Foreign Application Priority Data
Jul. 15, 2021 (EP) 21185927.7

(51) Int. Cl. C09J 133/08; B29B 17/02; B29K 33/00; C09J 7/38

(52) U.S. Cl. CPC C09J 133/08; C09J 7/385; B29B 17/0206; B29B 2017/0289; B29K 2033/08; C09J 2203/334; C09J 2301/122; C09J 2301/414; C09J 2400/143; C09J 2400/226; C09J 2400/28; C09J 2423/10; C09J 2433/00

(57) ABSTRACT

An aqueous pressure-sensitive adhesive composition for recycling-compatible pressure-sensitive adhesive labels is described. The adhesive composition comprises (A) a pressure-sensitive adhesive polymer made by emulsion polymerization of acrylic acid alkyl ester monomers and further monomers, and (B) a tackifier with a glass transition temperature of less than 5° C. Also described are recycling-compatible pressure-sensitive adhesive labels, packaging containers labelled with said labels and a method of recycling said labelled packaging containers.

The invention relates to aqueous pressure-sensitive adhesive compositions for recycling-compatible pressure-sensitive adhesive labels. The adhesive composition comprises (A) a pressure-sensitive adhesive polymer made by emulsion polymerization of acrylic acid alkyl ester monomers and further monomers, and (B) a tackifier with a glass transition temperature of less than 5° C. Also described are recycling-compatible pressure-sensitive adhesive labels, packaging containers labelled with said labels and a method of recycling said labelled packaging containers.

Recycling of plastic packaging is highly desirable for environmental and sustainability reasons to protect the environment and to conserve non-renewable resources. Consumer goods manufacturers need high-quality plastic recyclates to be reused in consumer good plastic packaging, such as for example polyethylene terephthalate (PET) bottles or polyolefin (PO) bottles. Used plastic packaging typically has labels attached to its surface and the labels need to be removed for forming high quality recyclate materials, necessary to produce new high quality plastic packaging.

Currently, pressure-sensitive adhesive labels, in particular filmic labels are difficult to detach from plastic packaging by washing with washing liquids. The backing material of filmic labels typically is not sufficiently water permeable and does not provide high permeability for wash liquids. Such filmic labels prevent the wash liquid from accessing the boundary between adhesive and container surface, and therefore, when conventional pressure-sensitive adhesives are used, the non-permeable polymeric film labels are only detachable slowly and at high temperatures, starting from the edge of the labels, which often does not allow complete label detachment within an economically acceptable time frame at desirable moderate washing temperatures (e.g. below 80° C.).

Special label technologies are known to facilitate label detachment, e.g. shrink sleeves, wrap-around labels, perforated film-based labels and shape-changing labels which are not dimensionally stable at higher temperatures. Such special labels are more costly and complicated to produce compared to conventional filmic labels based on pressure-sensitive adhesives, on account of a necessary pre-treatment or after-treatment of these special labels or on account of the need for a multiple-layer construction.

Therefore, a need exists for recycling-compatible aqueous pressure-sensitive adhesive compositions for producing recycling-compatible pressure-sensitive adhesive labels which allow quick and reliable label removability from plastic containers (e.g. made of polyolefin or polyethylene terephthalate) in a wash process using a washing liquid at only moderately elevated, energy saving temperatures (e.g. less than 80° C., particular preferred less than 70° C.) and wherein the labels may be conventional polymeric films which are not water-permeable, are non-perforated and are dimensionally stable on exposure to heat. In particular, an increasing demand for bottle-to-bottle polyolefin- or PET-recycling leads to the requirement of higher quality polyolefin or PET after the recycling process, requiring recycling-compatible pressure-sensitive label adhesives. A further important requirement of pressure-sensitive adhesive labels is that, while they should be very rapidly detachable using moderately heated wash liquid, they should nevertheless exhibit reliable bonding during ordinary lifetime of the labelled packaging. A particular challenge is to find an adhesive system which meets all of the stated—and in some cases divergent—requirements.

WO 93/13181 A1 and WO 2013/033486 A1 describe hot water and alkali removable pressure-sensitive adhesive compositions based on emulsion pressure-sensitive adhesive polymers, rosin acid tackifiers and rosin based surfactants for removing labels from a plastic article that is to be recycled. WO 2011/051373 describes adhesive labels which are removable by washing liquid and which comprise a branched or cross-linked pressure-sensitive adhesive polymer. TW 201738348 A describes flame-retardant water based PSA compositions comprising a specific, phosphorus containing adhesive polymer, dispersion tackifier and halogen-free flame-retardant.

The problem on which the invention is based is that of providing a recycling-compatible, aqueous pressure-sensitive adhesive for producing recycling-compatible pressure-sensitive adhesive labels for labelling plastic articles, using an aqueous adhesive system, which exhibits high resistance to premature label detachment when the labelled plastic articles are under normal use conditions, and yet which, on washing with wash liquids at only moderately elevated temperatures can be rapidly detached.

The invention provides an aqueous pressure-sensitive adhesive composition for recycling-compatible pressure-sensitive adhesive labels comprising
(A) a pressure-sensitive adhesive polymer dispersed in water with a glass transition temperature of −30° C. or less, preferably from −40 to −60° C., wherein the pressure-sensitive adhesive polymer is made by emulsion polymerization of
   (a) from 70 to 99.5 wt. % of acrylic acid alkyl ester monomers with 2 to 12 carbon atoms in the alkyl group;
   (b) at least from 0.4 wt. %, preferably more than 1 and preferably up to 10 wt. % of at least one ethylenically unsaturated, copolymerizable monomer having at least one acid group;
   (c) optionally one or more monomers selected from methyl acrylate, methyl methacrylate and methacrylic acid alkyl ester monomers with 2 to 12 carbon atoms in the alkyl group;
   (d) optionally one or more ethylenically unsaturated monomers different from monomers (a), (b) and (c);
   wt. % amounts of the monomers are based on the total weight amount of all monomers; and
(B) a tackifier with a glass transition temperature of less than 5° C., preferably less than 0° C.;
wherein the aqueous pressure-sensitive adhesive composition does not contain a halogen-free flame retardant in amounts of 15 to 45 weight parts, based on 100 parts of pressure-sensitive adhesive polymer in combination with a pressure-sensitive adhesive polymer made of 1 to 8 wt. % of phosphorous-containing monomers, based on the total weight amount of all monomers; wherein glass transition temperatures are measured by differential scanning calorimetry according to ASTM D 3418-08 as the midpoint temperature when evaluating the second heating curve at a heating rate of 20° C./min.

The invention also provides adhesive labels comprising a backing material having a first side and a second side, a pressure-sensitive adhesive layer attached to the first side of the backing material and either a release liner attached to the pressure-sensitive adhesive layer, or comprising a release-coating on the second side of the backing material, wherein the backing material is made of polymeric film, paper or a polymeric film/paper laminate, and the pressure-sensitive adhesive layer is made from an aqueous pressure-sensitive adhesive composition as described herein.

The invention also provides labelled packaging containers comprising a packaging substrate and an adhesive label, as described herein, attached to the surface of the packaging container, wherein the surface of the packaging container preferably is glass or plastic.

The invention also provides a method of recycling a labelled packaging container, the method comprising the steps of
(1) providing a labelled packaging container as described herein;
(2) shredding the labelled packaging container into smaller pieces;
(3) detaching label material from the shredded pieces by treating the shredded pieces with an aqueous washing composition;
(4) separating the shredded packaging material pieces from the detached label material and from the aqueous washing composition.

The invention also provides the use of an aqueous pressure-sensitive adhesive composition as described herein
(a) for making recycling-compatible adhesive labels (preferably filmic labels) as described herein; or
(b) for making recycling-compatible packaging containers labelled with a recycling-compatible adhesive labels (preferably filmic labels) as described herein; or
(c) in a method of recycling a labelled packaging container as described herein.

The text below occasionally uses the designation “(meth)acryl . . . ” and similar designations as an abbreviating notation for “acryl . . . or methacryl . . . ”. In the designation Cx alkyl (meth)acrylate and analogous designations, x denotes the number of carbon atoms in the alkyl group.

The glass transition temperature is determined by differential scanning calorimetry (ASTM D 3418-08, midpoint temperature). The glass transition temperature of the polymer in the polymer dispersion is the glass transition temperature obtained when evaluating the second heating curve at a heating rate of 20° C./min.

Particle diameters and particle size distribution can be measured by light scattering (photon correlation spectroscopy, ISO standard 13321:1996).

The terms “aqueous composition” and “aqueous polymer dispersion” refers to solvent systems primarily based on water, preferably containing no or less than 20%, less than 10%, less than 5%, less than 3% or less than 1% by weight of organic solvents (such as for example methanol, ethanol or tetrahydrofuran), based on the total composition. It is preferred not to use organic solvents.

A pressure-sensitive adhesive (PSA) is a viscoelastic adhesive whose set film at room temperature (20° C.) in the dry state remains permanently tacky and adhesive (self-adhesive). Bonding to substrates is accomplished instantaneously by gentle applied pressure. The loop tack of a dried film of the pressure-sensitive adhesive preferably is at least 2 N/25 mm, more preferred at least 2.5 N/25 mm or at least 3 N/25 mm, measured as described in the examples.

The term “recycling-compatible” means that the aqueous pressure-sensitive adhesive composition and the adhesive label as described can be removed by washing treatment from substrates which are intended to be recycled. The aqueous pressure-sensitive adhesive composition and the adhesive label as described herein are recycling-compatible to the extent that a pressure-sensitive adhesive label is detachable from polyethylene terephthalate articles preferably to a degree of at least 50%, more preferably at least 60%, more preferably at least 70% measured at 65° C. according to the detaching test described in the examples.

The aqueous pressure-sensitive adhesive composition comprises at least one tackifier. Tackifiers are chemical compounds often used in formulating adhesives to increase the tack, the stickiness of the surface of the adhesive. They are usually low-molecular weight compounds with high glass transition temperature (above room temperature). It now has been found that the use of specific tackifiers characterized by a particularly low glass transition temperature (below 5° C.) greatly enhances recycling-compatibility of adhesive labels. The glass transition temperature of the tackifier is less than 5° C., preferably less than 0° C., more preferably from −10 to −1° C., measured by differential scanning calorimetry according to ASTM D 3418-08.

The amount of the tackifiers is preferably from 5 to 100 parts by weight, more preferably from 10 to 50 parts by weight, per 100 parts by weight of polymer (solids/solids).

The acid number of the tackifier is preferably less than 20 mg KOH/g.

Tackifiers are, for example based on natural resins, such as rosin esters, rosins and their derivatives formed by disproportionation or isomerization, polymerization, dimerization, or hydrogenation. These natural resins can be present in their salt form (with monovalent or polyvalent counterions (cations), for example) or, preferably, in their esterified form. Alcohols used for the esterification of rosins can be monohydric or polyhydric. Examples are methanol, ethanediol, diethylene glycol, triethylene glycol, 1,2,3-propanetriol, pentaerythritol. Further tackifiers are terpenes, modified terpenes, aliphatic, cycloaliphatic and aromatic resins (C5 aliphatic resins, C9 aromatic resins, and C5/C9 aliphatic/aromatic resins), hydrogenated hydrocarbon resins, terpene-phenol resins, and their mixtures. Suitable tackifying hydrocarbon resins are for example coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, α-methylstyrene, vinyltoluene. Suitable tackifiers are also polyacrylates with a low molecular weight. Preferably these polyacrylates have a weight-average molecular weight M, below 30 000. The polyacrylates are composed preferably at least 60%, in particular at least 80%, by weight of C₁-C₈ alkyl (meth)acrylates.

Preferred tackifiers are natural or chemically modified rosins, rosin esters, terpene resins and their mixtures, such as for example Dermulsene® 222 or Snowtack® SE724G E. Rosins are composed predominantly of abietic acid or derivatives thereof.

### Pressure-Sensitive Adhesive Polymer

The aqueous pressure-sensitive adhesive composition comprises a pressure-sensitive adhesive polymer dispersed in water (aqueous adhesive polymer dispersion). The aqueous adhesive polymer dispersion of the invention forms an adhesive coating after application to a backing material and drying.

The aqueous adhesive polymer dispersion is obtainable by free radical emulsion polymerization of ethylenically unsaturated compounds (monomers).

### Monomers (a)

The monomer mixture for making the pressure-sensitive adhesive polymer comprises from 70 to 99.5 wt. %, preferably from 75 to 99.5 wt. %, from 80 to 99.5 wt. % or from 91 to 99.5 wt. %, based on the total amount of monomers, of acrylic acid alkyl ester monomers (a) with 2 to 12 carbon atoms in the alkyl group. Preferred monomers (a) are acrylic acid alkyl esters with 2 to 8 carbon atoms in the alkyl group. Preferred monomers (a) are ethyl acrylate, propyl acrylate, n-butyl acrylate, isobutyl acrylate, 2-ethylhexyl acrylate, tert-butyl acrylate, cyclohexyl acrylate, n-hexyl acrylate, n-octyl acrylate, 2-octyl acrylate, isooctyl acrylate, 2-propylheptyl acrylate and mixtures thereof. More preferred monomers (a) are one or more selected from ethyl acrylate, propyl acrylate, n-butyl acrylate, isobutyl acrylate, 2-ethylhexyl acrylate, n-octyl acrylate, 2-octyl acrylate and isooctyl acrylate. Particularly preferred are one or more of ethyl acrylate, n-butyl acrylate, isobutyl acrylate and 2-ethylhexyl acrylate.

### Monomers (b)

The monomer mixture for making the pressure-sensitive adhesive polymer comprises at least 0.4 wt. %, preferably more than 1 and preferably up to 10 wt. %, from more than 1 and up to less than 5 wt. % or from more than 1 and up to 4.5 wt. %, based on the total amount of monomers, of at least one ethylenically unsaturated, copolymerizable monomer having at least one acid group (acid monomer). The acid monomers (b) comprise monomers which contain at least one acid group, and also their anhydrides and salts thereof. The monomers (b) include alpha,beta-monoethylenically unsaturated monocarboxylic and dicarboxylic acids, monoesters of alpha,beta-monoethylenically unsaturated dicarboxylic acids, the anhydrides of the aforesaid alpha,beta-monoethylenically unsaturated carboxylic acids, and also ethylenically unsaturated sulfonic acids and their water-soluble salts, as for example their alkali metal salts. Examples thereof are acrylic acid, methacrylic acid, itaconic acid, maleic acid, fumaric acid, crotonic acid, vinylacetic acid, and vinyllactic acid. Examples of suitable ethylenically unsaturated sulfonic acids include vinylsulfonic acid, styrenesulfonic acid, acrylamidomethylpropane sulfonic acid, sulfopropyl acrylate and sulfopropyl methacrylate. Preferred monomers (b) are alpha,beta-monoethylenically unsaturated carboxylic acids with 3 to 8 carbon atoms and dicarboxylic acids with 4 to 8 carbon atoms, e.g., acrylic acid, methacrylic acid, itaconic acid, maleic acid, fumaric acid, crotonic acid, vinylacetic acid, vinyllactic acid, vinylsulfonic acid, styrenesulfonic acid, acrylamidoglycolic acid, acrylamidomethyl propane sulfonic acid, sulfopropyl acrylate, sulfopropyl methacrylate, their respective anhydrides and mixtures of these monomers. Particularly preferred monomers (b) are itaconic acid, acrylic acid and methacrylic acid.

### Monomers (c)

The monomer mixture for making the pressure-sensitive adhesive polymer optionally comprises one or more monomers selected from methyl acrylate, methyl methacrylate and methacrylic acid alkyl ester monomers with 2 to 12 carbon atoms in the alkyl group. The amount of monomers (c) is for example from 0 to 20 wt. %, based on the total amount of monomers. Preferably, the monomer mixture comprises no monomer (c) or the amount of monomers (c) is less than 10 wt. %, less than 5 wt. % or less than 1 wt. % of monomers (c). Monomers (c) are for example methyl methacrylate, methyl acrylate, ethyl methacrylate, propyl methacrylate, tert-butyl methacrylate, cyclohexyl methacrylate, 2-ethylhexyl methacrylate, lauryl methacrylate and iso-decyl methacrylate. In particular, mixtures of the alkyl (meth)acrylates are also suitable. If present, preferred monomers (c) are methyl acrylate, methyl methacrylate or a mixture thereof.

### Monomers (d)

The monomer mixture for making the pressure-sensitive adhesive polymer optionally comprises one or more monomers selected from ethylenically unsaturated monomers different from monomers (a), (b) and (c). Preferably, the monomer mixture does not comprise monomers with a phosphorous group. The amount of monomers (d) is for example from 0 to 20 wt. %, based on the total amount of monomers. Preferably, the monomer mixture comprises no monomer (d) or the amount of monomers (d) is from 0.1 to 10 wt. %, from 0.1 to 5 wt. % or from 0.2 to 1 wt. %. Monomers (d) are for example selected from hydroxyalkyl (meth)acrylates having from 1 to 10 C atoms, preferably from 1 to 4 C atoms in the hydroxyalkyl group, vinyl esters of carboxylic acids comprising up to 20 C atoms, vinylaromatics having up to 20 C atoms, ethylenically unsaturated nitriles, amides of ethylenically unsaturated carboxylic acids (preferably acrylamide or meth-acrylamide), N-alkylolamides of ethylenically unsaturated carboxylic acids (preferably N-methylol acrylamide and N-methylol methacrylamide), phenyloxyethyl glycol mono(meth)-acrylates, vinyl halides, vinyl ethers of alcohols comprising 1 to 10 C atoms, aliphatic hydro-carbons having 2 to 8 carbon atoms and one or two double bonds, ethylenically unsaturated monomers containing amino groups, bifunctional monomers which as well as an ethylenically unsaturated double bond have at least one glycidyl group (preferably glycidyl acrylate or glycidyl methacrylate), oxazoline group, ureido group, ureido-analogous group or carbonyl group, preferably diacetone acrylamide, and crosslinking monomers which have more than one free-radically polymerizable ethylenically unsaturated group, or mixtures of these monomers.

Hydroxyalkyl (meth)acrylates having from 1 to 10 C atoms in the alkyl group are for example hydroxyethyl acrylate, hydroxyethyl methacrylate, hydroxypropyl acrylate, hydroxypropyl methacrylate and 4-hydroxybutyl acrylate. Vinyl esters of carboxylic acids having 1 to 20 carbons are, for example, vinyl laurate, vinyl stearate, vinyl propionate, Versatic acid vinyl esters, and vinyl acetate. Useful vinylaromatic compounds include vinyltoluene, alpha- and para-methylstyrene, alpha-butylstyrene, 4-n-butylstyrene, 4-n-decylstyrene and, preferably, styrene. Monomers containing amino groups are for example the aminoalkyl esters of the aforesaid alpha,beta-monoethylenically unsaturated carboxylic acids, preferably C₁-C₁₀ aminoalkyl (meth)acrylates such as, for example, 2-aminoethyl (meth)acrylate or tert-butyl-aminoethyl methacrylate. Examples of nitriles are the nitriles of alpha,beta-monoethylenically unsaturated C3-C8 carboxylic acids, preferably acrylonitrile and methacrylonitrile. The vinyl halides are ethylenically unsaturated compounds substituted by chlorine, fluorine or bromine, preferably vinyl chloride and vinylidene chloride. Examples of vinyl ethers which may be mentioned are vinyl methyl ether or vinyl isobutyl ether. Preference is given to vinyl ethers of alcohols comprising 1 to 4 carbons. Hydrocarbons having 4 to 8 carbons and two olefinic double bonds include butadiene, isoprene and chloroprene. Monomers with an ureido group are monomers having a substituent of formula

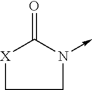

where X is NH or NR and R is an organic group such as for example alkyl, preferably alkyl with 1 to 4 C-atoms. The arrow at the N-atoms indicates the connection to the remaining part of the monomer, preferably a (meth)acrylate monomer. A preferred example is. Monomers with an ureido-analogous groups are monomers having a substituent of the above formula where X is O or CH₂.

A preferred aqueous pressure-sensitive adhesive composition comprises a pressure-sensitive adhesive polymer made by emulsion polymerization wherein
the monomers (a) are used in an amount of 80 to 99.5 wt. %, preferably from 91 to 99.5 wt. %, based on the total amount of monomers and are one or more selected from ethyl acrylate, propyl acrylate, n-butyl acrylate, isobutyl acrylate, 2-ethylhexyl acrylate, n-octyl acrylate, 2-octyl acrylate and isooctyl acrylate;
the monomers (b) having at least one acid group are used in an amount of more than 1 and up to 4.5 wt. %, based on the total amount of monomers, and are one or more selected from acrylic acid, methacrylic acid, itaconic acid and acrylamidomethylpropane sulfonic acid;
monomers (c) are used in amounts of from 0 to 15 wt. %, based on the total amount of monomers, and are methyl acrylate, methyl methacrylate or a mixture thereof; and
the monomers (d) are used in an amount of 0.1 to 10 wt. %, based on the total amount of the monomers, and are one or more selected from acrylamide, and hydroxyalkyl (meth)acrylates having from 1 to 4 C atoms in the alkyl group.

Preferably and for sustainability reasons, bio-based materials are used for producing the pressure-sensitive adhesive polymer, which preferably is partly or completely made of partly or fully bio-based monomers. Bio-based materials are materials which are made from a renewable source and have a smaller impact on the environment. They do not require all the refining steps required for petroleum-based products, which are very expensive in terms of energy. The production of CO₂ is reduced such that they contribute less to global warming. The term “bio-based” indicates that the material is of biological origin and comes from biomaterial/renewable resources. A material of renewable origin or biomaterial is an organic material wherein the carbon comes from the CO₂ fixed recently (on a human scale) by photosynthesis from the atmosphere. A biomaterial (carbon of 100% natural origin) has an isotopic ratio ¹⁴C/¹²C greater than 10⁻¹², typically about 1.2×10⁻¹², while a fossil material has a zero ratio. Indeed, the isotopic ¹⁴C is formed in the atmosphere and is then integrated via photosynthesis, according to a time scale of a few tens of years at most. The half-life of the ¹⁴C is 5730 years. Thus, the materials coming from photosynthesis, namely plants in general, necessarily have a maximum content in isotope ¹⁴C. The determination of the content of biomaterial or of bio-carbon can be carried out in accordance with the standards ASTM D 6866-12, the method B (ASTM D 6866-06) and ASTM D 7026 (ASTM D 7026-04). Preferably, the pressure-sensitive adhesive polymer has a content of bio-carbon of at least 10 mol-%, in particular at least 15 mol-% or at least 20 mol-% or higher, e.g. 30 mol-% or 40 mol-% or higher, based on the total amount of carbon atoms in the pressure-sensitive adhesive polymer. A polymer which is partly made of fully or partly biobased monomers is a polymer where not all monomers used in the polymerization are partly or fully biobased monomers. A partly biobased monomer is a monomer where not all C-atoms are biobased, for example (meth)acrylic acid esters where only the acid part or only the alcohol part is biobased.

Suitable bio-based materials for producing the pressure-sensitive adhesive polymer are for example (meth)acrylic esters, wherein the (meth)acrylic acid component or the alcohol component or both are bio-based. Various methods of producing bio-based acrylic acid from renewable plant materials are mentioned in EP 2626397 A1. Suitable bio-based alcohols are for example bio-based n-butanol, bio-based isobutanol, bio-based iso-pentanol (3-methylbutan-1-ol), bio-based 2-octanol and bio-based n-heptanol. Preferably, at least 50% of the monomers are at partly or fully bio-based monomers. Preferred partly biobased monomers are esters of (meth)acrylic acid and bio-based alcohols, preferably bio-based n-butanol, bio-based isobutanol (2-methylpropan-1-ol), bio-based iso-pentanol (3-methylbutan-1-ol), bio-based 2-octanol and bio-based n-heptanol. Preferred fully biobased monomers are esters of bio-based acrylic acid and bio-based alcohols as mentioned above.

The pressure-sensitive adhesive polymer has a glass transition temperature of −30° C. or less, preferably from −40 to −60° C. Therefore, the monomers of the polymerization are selected such that the glass transition temperature is −30° C. or less, preferably from −40 to −60° C. By purposive variation of monomer type and quantity, those skilled in the art are able according to the invention to prepare aqueous polymeric compositions whose polymers have a glass transition temperature in the desired range. Orientation is possible by means of the Fox equation. According to Fox (T. G. Fox, Bull. Am. Phys. Soc. 1956 [Ser. II] 1, page 123, and according to Ullmann's Encyclopädie der technischen Chemie, Vol. 19, page 18, 4th edition, Verlag Chemie, Weinheim, 1980), the glass transition temperature of copolymers is given to a good approximation by:

$$1 /= / {T}_{g} = {x}^{1} / {T}_{g}^{2} + {x}^{2} / {T}_{g}^{2} + … . {x}^{n} / {T}_{g}^{n} ,$$

where x¹, x², . . . xⁿ are the mass fractions of the monomers 1, 2, . . . n and T_{g}¹, T_{g}², . . . T_{g}ⁿ are the glass transition temperatures in degrees Kelvin of the polymers synthesized from only one of the monomers 1, 2, . . . n at a time. The T_{g} values for the homopolymers of the majority of monomers are known and are listed for example in Ullmann's Encyclopaedia of Industrial Chemistry, Vol. 5, Vol. A21, page 169, VCH Weinheim, 1992; further sources for glass transition temperatures of homopolymers are, for example, J. Brandrup, E. H. Immergut, Polymer Handbook, 1^{st} Ed., J. Wiley, New York 1966, 2^{nd} Ed. J. Wiley, New York 1975, and 3^{rd} Ed. J. Wiley, New York 1989.

It has been found that particularly good label removability can be achieved when the pressure-sensitive adhesive polymer in addition to the (first) glass transition temperature of −30° C. or less, as mentioned above, has a second glass transition temperature above 0° C., preferably from 5 to 30° C. or from 10 to 25° C. These preferred pressure-sensitive adhesive polymers preferably have more than 1 and up to 10 wt. %, based on the total amount of monomers, of the at least one ethylenically unsaturated, copolymerizable monomer having at least one acid group (acid monomer).

The pressure-sensitive adhesive polymer dispersion is prepared by emulsion polymerization. Emulsion polymerization comprises polymerizing ethylenically unsaturated compounds (monomers) in water using typically ionic and/or nonionic emulsifiers and/or protective colloids or stabilizers as surface-active compounds to stabilize the monomer droplets and the polymer particles subsequently formed from the monomers. A detailed description of suitable protective colloids is found in Houben-Weyl, Methoden der organischen Chemie, Volume XIV/1, Makromolekulare Stoffe [Macromolecular Compounds], Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are usually below 2000 g/mol. Where mixtures of surface-active substances are used the individual components must of course be compatible with one another, something which in case of doubt can be checked by means of a few preliminary tests. Preference is given to using anionic and nonionic emulsifiers as surface-active substances. Common accompanying emulsifiers are, for example, ethoxylated fatty alcohols (EO units: 3 to 50, alkyl radical: C₈ to C₃₆), ethoxylated mono-, di-, and tri-alkylphenols (EO units: 3 to 50, alkyl radical: C₄ to C₉), alkali metal salts of dialkyl esters of sulfosuccinic acid and also alkali metal salts and ammonium salts of alkyl sulfates (alkyl radical: C₈ to C₁₂), of ethoxylated alkanols (EO units: 4 to 30, alkyl radical: C₁₂ to C₁₈), of ethoxylated alkylphenols (EO units: 3 to 50, alkyl radical: C₄ to C₉), of alkylsulfonic acids (alkyl radical: C₁₂ to C₁₈), and of alkylarylsulfonic acids (alkyl radical: C₉ to C₁₈).

Further suitable emulsifiers are compounds of the general formula II

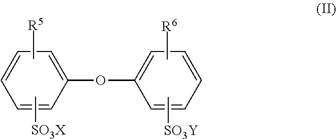

in which R⁵ and R⁶ are hydrogen or C₄ to C₁₄ alkyl and are not simultaneously hydrogen, and X and Y can be alkali metal ions and/or ammonium ions. Preferably R⁵ and R⁶ are linear or branched alkyl radicals having 6 to 18 carbon atoms or hydrogen and in particular having 6, 12, and 16 carbon atoms, with R⁵ and R⁶ not both simultaneously being hydrogen. X and Y are preferably sodium, potassium or ammonium ions, with sodium being particularly preferred. Particularly advantageous compounds are compounds II in which X and Y are sodium, R⁵ is a branched alkyl radical having 12 carbon atoms, and R⁶ is hydrogen or R⁵. Frequently use is made of technical-grade mixtures which contain a fraction of from 50 to 90% by weight of the monoalkylated product, an example being Dowfax® 2A1 (trade mark of the Dow Chemical Company). Suitable emulsifiers are also found in Houben-Weyl, Methoden der organischen Chemie, Volume 14/1, Makromolekulare Stoffe [Macromolecular Compounds], Georg Thieme Verlag, Stuttgart, 1961, pages 192 to 208. Examples of emulsifier trade names include Dowfax® A1, Emulan® NP 50, Dextrol® OC 50, Emulgator 825, Emulgator 825 S, Emulan® OG, Texapon® NSO, Nekanil® 904 S, Lumiten® I-RA, Lumiten® E 3065, Disponil® FES 77, Lutensol® AT 18, Steinapol VSL, and Emulphor NPS 25. For the present invention non-ionic emulsifiers, ionic emulsifiers or protective colloids may be used. The compounds in question may be ionic emulsifiers, especially salts and acids, such as carboxylic acids, sulfonic acids, and sulfates, sulfonates or carboxylates. In particular it is also possible to use mixtures of ionic and nonionic emulsifiers. The surface-active substance is used usually in amounts of from 0.1 to 10 parts by weight, preferably from 0.2 to 5 parts by weight per 100 parts by weight of the monomers to be polymerized.

Water-soluble initiators for the emulsion polymerization are for example ammonium salts and alkali metal salts of peroxodisulfuric acid, e.g., sodium peroxodisulfate, hydrogen peroxide or organic peroxides, e.g., tert-butyl hydroperoxide. Also suitable are what are called reduction-oxidation (Red-Ox) initiator systems. The Red-Ox initiator systems are composed of at least one, usually inorganic, reducing agent and one organic or inorganic oxidizing agent. The oxidizing component comprises, for example, the initiators already mentioned above for the emulsion polymerization. The reducing components comprise, for example, alkali metal salts of sulphurous acid, such as sodium sulphite, sodium hydrogen sulfate, alkali metal salts of disulfurous acid such as sodium disulfite, bisulfite addition compounds of aliphatic aldehydes and ketones, such as acetone bisulfite, or reducing agents such as hydroxymethanesulfinic acid and the salts thereof, or ascorbic acid. The red-ox initiator systems can be used together with soluble metal compounds whose metallic component is able to exist in a plurality of valence states. Customary Red-Ox initiator systems are, for example, ascorbic acid/iron(II) sulfate/sodium peroxodisulfate, tert-butyl hydroperoxide/sodium disulfite, tert-butyl hydroperoxide/Na hydroxymethanesulfinate. The individual components, the reducing component for example, can also be mixtures, an example being a mixture of the sodium salt of hydroxymethanesulfinic acid and sodium disulfite. The compounds stated are used generally in the form of aqueous solutions, the lower concentration being determined by the amount of water that is acceptable in the dispersion and the upper concentration by the solubility of the respective compound in water. In general the concentration is from 0.1 to 30% by weight, preferably from 0.5 to 20% by weight, more preferably from 1.0 to 10% by weight, based on the solution. The amount of the initiators is generally from 0.1 to 10% by weight, preferably from 0.5 to 5% by weight, based on the monomers to be polymerized. It is also possible for two or more different initiators to be used in the emulsion polymerization.

For the polymerization it is possible to use molecular weight regulators (also called chain transfer agents). By this means it is possible to reduce the molar mass of the emulsion polymer through a chain termination reaction. The chain transfer agents are bonded to the polymer in this procedure, generally to the chain end. The amount of the chain transfer agents is preferably 0.05 to 4 parts by weight, more preferably 0.05 to 0.8 part by weight, and very preferably 0.1 to 0.6 part by weight, per 100 parts by weight of the monomers to be polymerized. Suitable chain transfer agents are, for example, compounds having a thiol group such as tert-butyl mercaptan, thioglycolic acid 2-ethylhexyl ester, mercaptoethanol, mercaptopropyl trimethoxysilane or tert-dodecyl mercaptan. The chain transfer agents are preferably compounds of low molecular mass, having a molar weight of less than 2000, more particularly less than 1000 g/mol. Preferred are 2-ethylhexyl thioglycolate (EHTG), isooctyl 3-mercaptopropionate (IOMPA) and tert-dodecyl mercaptan (tDMK).

The emulsion polymerization takes place in general at from 30 to 130° C., preferably from 50 to 90° C. The polymerization medium may be composed either of water alone or of mixtures of water and liquids miscible therewith such as methanol. Preferably just water is used. The emulsion polymerization can be carried out either as a batch operation or in the form of a feed process, including staged or gradient procedures. Preference is given to the feed process, in which a portion of the polymerization mixture is introduced as an initial charge, heated to the polymerization temperature, and subjected to partial polymerization and then the remainder of the polymerization mixture is supplied to the polymerization zone, usually by way of two or more spatially separate feeds, of which one or more comprise(s) the monomers in pure form or in emulsified form, continuously, in stages or subject to a concentration gradient, during which the polymerization is maintained. In the polymerization it is also possible for a polymer seed to be included in the initial charge in order, for example, to establish the particle size more effectively.

The manner in which the initiator is added to the polymerization vessel in the course of the free-radical aqueous emulsion polymerization is known to one of ordinary skill in the art. Either it can be included in its entirety in the initial charge to the polymerization vessel or else it can be inserted continuously or in stages at the rate at which it is consumed in the course of the free-radical aqueous emulsion polymerization. For any given case this will depend both on the chemical nature of the initiator system and on the polymerization temperature. Preferably some of it is included in the initial charge and the remainder is supplied to the polymerization zone at the rate at which it is consumed. To remove residual monomers it is usual to add initiator after the end of the emulsion polymerization, i.e., after a monomer conversion of at least 95%. The individual components can be added to the reactor, in the case of the feed process, from above, in the side, or from below, through the reactor floor.

The polymerization may take place with seed control, i.e., in the presence of polymer seed (seed latex). Seed latex is an aqueous dispersion of finely divided polymer particles having an average particle diameter of preferably 20 to 40 nm. Seed latex is used in an amount of preferably 0.01 to 0.5 part by weight, more preferably of 0.03 to 0.3 part by weight, or of 0.03 to less than or equal to 0.1 part by weight, per 100 parts by weight of monomers. Suitable seed latex is for example a latex based on polystyrene or based on polymethyl methacrylate. A preferred seed latex is polystyrene seed.

In the preparation of the pressure-sensitive adhesive polymer by free-radically initiated aqueous emulsion polymerization it is of course possible to use further, optional auxiliaries familiar to the skilled person, such as, for example, those known as thickeners, defoamers, neutralizing agents, buffer substances, preservatives, free-radical chain-transfer compounds and/or inorganic fillers.

Acid groups in the polymer may be neutralized by the feeding of a neutralizing agent during or after polymerization, with the acid groups being neutralized wholly or partly by the feeding of the base. The pH of the pressure-sensitive adhesive polymer dispersion is preferably adjusted to a pH greater than 5, more particularly to a pH of between 5 and 9 or between 5.5 and 8.

The aqueous pressure-sensitive adhesive composition preferably comprises 15 to 75 wt. %, more preferably from 40 to 60 wt. %, more particularly more than 50 and up to 60 wt. % of the pressure-sensitive adhesive polymer. The solids content may be adjusted, for example, by appropriate adjustment of the amounts of monomers and/or the amount of water used in the emulsion polymerization.

The aqueous pressure-sensitive adhesive composition may comprise solely the aqueous dispersion of the polymer and the tackifier.

The aqueous pressure-sensitive adhesive composition may optionally comprise further additives, such as at least one additive selected from the group consisting of crosslinking agents, wetting agents, fillers, dyes, flow agents, thickeners, light stabilizers, biocides, defoamers. The amount of additives (other than tackifiers) is preferably 0.05 to 5 parts by weight, or 0.1 to 3 parts by weight of solids per 100 parts by weight of adhesive polymer (solid). The aqueous pressure-sensitive adhesive composition does not comprise a water-dispersible halogen-free flame retardant in amounts of 15 to 45 weight parts, based on 100 weight parts of pressure-sensitive adhesive polymer in combination with a pressure-sensitive adhesive polymer made of 1 to 8 wt. % of phosphorous-containing monomers. The aqueous pressure-sensitive adhesive composition preferably does not contain any halogen-free flame retardant. The pressure-sensitive adhesive polymer preferably is not made from any phosphorous-containing monomer.

A preferred aqueous pressure-sensitive adhesive composition comprises one or more crosslinking agents. Preferred amounts of crosslinking agents are from 0.01 to 5 parts by weight, more particularly from 0.1 to 3 parts by weight, and with particular preference from 0.2 to parts by weight, based on 100 parts by weight of pressure-sensitive adhesive polymer. Preferred crosslinking agents are selected from the group consisting of aminotriazines, iso-cyanurates formed from diisocyanates and having at least two isocyanate groups, compounds having at least one carbodiimide group, chemically capped isocyanates, encapsulated isocyanates, encapsulated uretdiones, biurets, allophanates, aziridines, oxazolines, epoxides, and mixtures of the substances mentioned.

Preferably, crosslinking is accomplished through addition of at least one aminotriazine compound. The amount of aminotriazine compound is preferably from 0.01 to 5 parts by weight, more particularly from 0.1 to 3 parts by weight, and with particular preference from 0.2 to 2 parts by weight, based on 100 parts by weight of pressure-sensitive adhesive polymer. Aminotriazine compounds are, for example, melamine, benzoguanamine, acetoguanamine, and bisguan-amines such as adipo-, glutaro- or methylglutaro-bisguanamine, and spiroguanamines. Also contemplated are compounds which comprise two or more aminotriazine nuclei—which, for example, are fused. The aminotriazine compounds are preferably at least partly methylolated and etherified. Preference is given to at least partly methylolated and etherified melamine and corresponding compounds which comprise two or more melamine nuclei, e.g., 2 to 5 melamines bridged via methylol groups, or mixtures thereof. Preferred aminotriazines comprise on average 1 to 3, more particularly 1, melamine nucleus per molecule. Preference is given more particularly to melamine-formaldehyde resins, in particular methylated melamine-formaldehyde resins. The aminotriazines are methylolated with on average at least 1 mol, preferably at least 1.4 mol, more preferably with at least 1.7 mol of formaldehyde per equivalent of primary amino groups, and these methylol groups are etherified on average with at least 0.5 mol, preferably at least 0.6 mol, and more preferably with at least 0.7 mol of primary alcohols per equivalent of methylol group. Primary alcohols preferred for this purpose are C₁-C₄ alkanols in particular. Methanol is particularly preferred. One preferred aminotriazine compound is, for example, hexamethoxymethylol melamine, with each amino group of the melamine being methylolated with 2 formaldehyde groups, and each methylol group etherified with methanol. Preferred aminotriazine compounds have a water solubility of at least 500 g/litre of water (21° C., 1 atm absolute). The aminotriazine compounds are used preferably in the form of their aqueous solutions. Such products are familiar to the skilled person and are freely available commercially on the market, for example, under the brand name Luwipal® 073 or Saduren® 163 (products of BASF SE).

The preparation of the adhesive formulation by mixing of adhesive polymer and aminotriazine compound is not critical and may in principle take place in any order, particularly when the adhesive polymer is used in the form of an aqueous polymer dispersion and the aminotriazine compound in the form of an aqueous solution. Preferably, the aqueous solution of the aminotriazine compound is added to the aqueous dispersion of the adhesive polymer.

The adhesive composition is preferably one-component and not radiation-curable, and hence need not be mixed with a second reactive component prior to application, and need not be irradiated in order to cure or activate the adhesive.

The weight average particle size of the polymer particles dispersed in the aqueous dispersion is preferably less than 400 nm, more particularly less than 300 nm. With particular preference the average particle size is between 140 and 250 nm. The adhesive polymer may have a mono-modal particle size distribution. The adhesive polymer may have a bimodal or a multimodal particle size distribution. “Multimodal” means more than two particle modes. The size distribution of the dispersion particles is monomodal when measurement of the particle size distribution contains only one single maximum. A bimodal particle size distribution is a particle size distribution defined by exhibiting two distinct maxima in the particle size measurement. A multimodal particle size distribution is a particle size distribution defined by exhibiting more than two distinct maxima in the particle size measurement. Preferably, a first particle mode has a weight average particle diameter in the range of 50 to 200 nm, preferably from 100 to 200 nm. A second particle mode has a weight average particle diameter preferably in the range of from above 250 nm and up to 1200 nm, preferably from above 300 and up to 900 nm. Preferably, the average particle diameters of the first and second mode differ by at least 50 nm. Particle sizes can be measured by laser light scattering.

The viscosity of the aqueous adhesive dispersion is preferably not more than 1500 mPa s and preferably at least 50 mPa s, for example from 50 to 800 mPa s measured in accordance with DIN EN ISO 3219 at 23° C. and 250 sec⁻¹.

The invention provides an adhesive label comprising a backing material having a first side and a second side, a pressure-sensitive adhesive layer attached to the first side of the backing material and either a release liner attached to the pressure-sensitive adhesive layer, or comprising a release-coating on the second side of the backing material, wherein the backing material is made of a polymeric film, paper or a polymeric film/paper laminate, and the pressure-sensitive adhesive layer is made from an aqueous pressure-sensitive adhesive composition as described herein. The backing material is water-insoluble, which means that it does not dissolve in water at room temperature (25° C.) and, preferably, not at temperatures of the washing operation either, which may be 55° C. or higher, for example.

Polymeric films are for example films of polyolefins, polyvinyl chloride (PVC), polyamide (PA), polyethylene terephthalate (PET), cellulose, cellophane, polyacetate, polyester (preferably biodegradable polylactates), polyolefin copolymers, for example cycloolefin copolymer (COC). Films of polyolefins are for example made of polyethylene or polypropylene (e.g. unoriented polypropylene (CPP) or oriented polypropylene (OPP)), preferably biaxially oriented polypropylene. The backing material is preferably selected from polyolefins, wet-strength regenerated cellulose film and wet-strength paper, preferably biaxially oriented polypropylene. The polymeric films are preferably transparent. Transparent polymer films are for example polyolefins (such as polyethylene or polypropylene), PVC or polyethylene terephthalate (PET). PVC may be plasticized PVC. By plasticized PVC is meant polyvinyl chloride which includes plasticizers and has a reduced softening temperature. Examples of customary plasticizers are phthalates, epoxides, adipic esters. The amount of plasticizers in the plasticized PVC is preferably more than 10% and in particular more than 20% by weight.

Surface treatment of polymeric film substrates ahead of coating with an adhesive polymer dispersion of the invention is not absolutely necessary. However, better results can be obtained if the surface of the polymeric film substrates is modified prior to coating. In this case it is possible to employ customary surface treatments, such as corona treatment in order to boost the adhesion. The corona treatment or other surface treatments are carried out to the extent required for sufficient wettability with the coating composition. Customarily, corona treatment of approximately 10 watts per square meter per minute is sufficient for this purpose. Alternatively or additionally it is also possible, optionally, to use primers between film substrate and adhesive coating.

Effective detachability does not necessarily require the adhesive label to be perforated or to have similar auxiliary means for allowing rapid contact between wash water and adhesive during the washing operation. In accordance with the invention, sufficiently rapid detachment of the label material from the labelled substrate is possible even without such auxiliary means. Nor is it necessary for the label to change its shape during the washing operation, in order to facilitate label detachment by means of the forces that accompany the change in shape. Therefore, the backing material of the adhesive labels preferably is not perforated and preferably is dimensionally stable under wash-off conditions, i.e. is not a shrink film, and preferably does not exhibit any changes in shape on exposure to heat during wash removal.

The thickness of the label backing material is preferably from 10 to 200 μm or from 30 to μm. The backing material can be coated in customary fashion to produce the layer of adhesive on the backing material. The labels are coated on one side with adhesive, the coated surface being at least partly coated with an adhesive composition of the invention. The adhesive may be applied to the articles by typical methods such as knife coating, spreading, roller coating, reverse roller coating, gravure roller coating, reverse gravure roller coating, brush coating, rod coating, spray coating, airbrush coating, meniscus coating, curtain coating or dip coating. The amount applied is preferably 5 to 30 g, more particularly 10 to 30 g, or 10 to 20 g, or 12 to 15 g of solid per m². Application is generally followed by a drying step for removal of the water and the solvents.

The invention also provides a labelled packaging container comprising a packaging substrate and an adhesive label (as described herein) attached to the surface of the packaging container, wherein the surface of the packaging container preferably is glass or plastic. The adhesive label is adhered to the substrate of the packaging container, e.g., an item of food packaging made of glass or plastic, more particularly a beverage bottle. Preferred packaging containers are bottles of glass or plastic, most preferred of polyethylene terephthalate (PET).

The invention also provides a method of recycling a labelled packaging container, the method comprising the steps of
(1) providing a labelled packaging container as described herein;
(2) shredding the labelled packaging container into smaller pieces;
(3) detaching label material from the shredded pieces by treating the shredded pieces with an aqueous washing composition;
(4) separating the shredded packaging material pieces from the detached label material and from the aqueous washing composition.

The label material is removed from the substrate material of the packaging container by washing with an aqueous basic wash liquid. The temperature of the wash liquid preferably is greater than 25° C., more preferred at least 50° C. The temperature of the wash liquid preferably is up to 70° C. or less than 70°, most preferred in the range of from 55° C. to less than 70° C., e.g. about 65° C. The pH of the wash liquid is basic, i.e., greater than 7, more particularly from 10 to 14, preferably from 12 to 14 or from 13 to 14.

The aqueous washing composition preferably contains 1 to 2 wt. % of alkali metal hydroxide, preferably sodium hydroxide or potassium hydroxide. The aqueous washing composition preferably contains at least one surfactant.

Preferably less than 10% by weight, or less than 5% by weight, or no adhesive remains adhering to the detached label following the adhering of the label to a substrate (e.g., glass or plastic such as polyethylene terephthalate for example), and its later detachment using basic, aqueous wash liquid.

Preferably less than 10% by weight, or less than 5% by weight, or no adhesive remains adhering to the substrate material of a packaging container following the adhering of the label to the substrate material (e.g., glass or plastic such as polyethylene terephthalate), and its later detachment using basic, aqueous wash liquid.

The invention also provides the use of an aqueous pressure-sensitive adhesive composition as described herein
(a) for making recycling-compatible adhesive labels (preferably filmic labels) as described herein; or
(b) for making recycling-compatible packaging containers labelled with a recycling-compatible adhesive label (preferably with a filmic label), as described herein; or
(c) in a method of recycling a labelled packaging container as described herein.

Particular advantages of the invention are that adhesive labels are provided with sufficient adhesive strength on packaging containers of glass or plastic during ordinary lifetime of the labelled packaging container, wherein the label material can be removed from the packaging containers by washing with aqueous washing compositions at comparable low, energy saving temperatures.

### EXAMPLES

The ingredients used were as follows:
Dermulsene® 222 tackifier, solvent-free, water-based dispersion of terpene resin and rosin ester, 54% solids; Tg −2° C.
Snowtack®765A tackifier; 50% rosin acid dispersion; Tg 12° C.
Snowtack®779F tackifier; 59% rosin acid dispersion; Tg 21° C.
Snowtack®933E tackifier; rosin ester dispersion; Tg 20° C.
Snowtack® SE780G tackifier; 55% rosin ester dispersion; Tg 34° C.

Viscosities are measured at 23° C. and 250 1/s, according to DIN EN ISO 3219.

### Pressure-Sensitive Adhesive Polymer Dispersions

### Example P1

Acrylic copolymer dispersion made by emulsion polymerization of (amounts in parts by weight): 0.5 parts acrylic acid, 0.41 parts acrylamide, 29 parts n-butyl acrylate, 70.09 parts 2-ethylhexyl acrylate.
solids content: 54.8%; viscosity: 55 mPa s; Tg: −59.4° C.

### Example P2

Acrylic copolymer dispersion made by emulsion polymerization of (amounts in parts by weight): 0.99 parts acrylic acid, 0.41 parts acrylamide, 29 parts n-butyl acrylate, 69.6 parts 2-ethylhexyl acrylate.
solids content: 55.0%; Tg: −59.1° C.; viscosity: 71 mPa s

### Example P3

Acrylic copolymer dispersion made by emulsion polymerization of (amounts in parts by weight): 2.0 parts acrylic acid, 0.41 parts acrylamide, 29 parts n-butyl acrylate, 68.59 parts 2-ethylhexyl acrylate.
solids content: 54.8%; Tg: −58.6° C.; Tg2: 16.6° C.; viscosity: 83 mPa s

### Example P4

Acrylic copolymer dispersion made by emulsion polymerization of (amounts in parts by weight): 3.0 parts acrylic acid, 0.41 parts acrylamide, 29 parts n-butyl acrylate, 67.59 parts 2-ethylhexyl acrylate.
solids content: 54.5%; Tg1: −57.9° C.; Tg2: 19.1° C.; viscosity: 116 mPa s

### Example P5

Acrylic copolymer dispersion made by emulsion polymerization of (amounts in parts by weight): 4.0 parts acrylic acid, 0.41 parts acrylamide, 29 parts n-butyl acrylate, 66.59 parts 2-ethylhexyl acrylate.
solids content: 54.5%; Tg1: −57.3° C.; Tg2: 15.9° C.; viscosity: 176 mPa s

### Aqueous Pressure-Sensitive Adhesive Compositions

### Examples Px/Ty

The acrylic copolymer dispersions of example P1 to P5 are formulated with the tackifiers T1 to T5 listed in table 1 resulting in the aqueous pressure-sensitive adhesive compositions P1/T1 to P5/T5 according to table 2. Formulation is done by adding 20 wt. % of tackifier (based on solids) to 80 wt. % of pressure-sensitive adhesive polymer (based on solids). The compositions are named according to their adhesive polymer/tackifier formulation, e.g. example P1/T1 is the composition of adhesive polymer P1 and tackifier T1.

### Example P2/C

100 parts by weight (based on solids) of the acrylic copolymer dispersion of example P2 is formulated with 1.32 parts (as is) of crosslinker Saduren®163 (methylated melamine-formaldehyde resin).

### Example P4/T1/C

70 parts by weight (based on solids) of the acrylic copolymer dispersion of example P4 is formulated with 30 parts (based on solids) of tackifier T1 (Dermulsene®) and 1.32 parts (as is) of crosslinker Saduren®163.

TABLE 1
Tackifier

| | Tg | Acid value |
|---|---|---|
| Tackifier | [° C.] | [mg KOH/g] |
| T1: Dermulsene ® 222 | −2 | 10-15 |
| T2: Snowtack ® 765A | 12 | >100 |
| T3: Snowtack ® 779F | 21 | 145 |
| T4: Snowtack ® 933E | 20 | <20 |
| T5: Snowtack ® SE780G | 34 | <20 |

* measured by differential scanning calorimetry (DSC) after drying

Alternatively, Snowtack® SE724G (rosin ester dispersion, Tg −8° C., acid value<25 mg KOH/g) can be used instead of Dermulsene® 222.

### Label Preparation

The aqueous pressure-sensitive adhesive compositions are applied to siliconized carrier paper (release liner) with a doctor blade and then dried for 3 min at 90° C. in a drying cabinet. The dry application weight is 17 g/m². After drying, the pressure-sensitive adhesive coating is covered with a 40 μm thick film made of biaxially oriented polypropylene (BOPP), so that a three-layer laminate of siliconized carrier paper, dried adhesive composition and BOPP is produced. Before test, this laminate is stored for at least 16 hours at 23° C. at 50% humidity.

### Detaching Test

To test the pressure-sensitive adhesive label, the BOPP film was peeled off the siliconized paper release liner together with the pressure-sensitive adhesive and stuck onto a 1 l PET bottle. The bottle was then stored for at least 16 h at 23° C. and 50% humidity. Then a 100 cm² area, completely covered with the BOPP label, was cut out of the bottle and crushed into 1×1 cm² flakes. 300 ml of an aqueous wash solution of NaOH (1 wt. %; pH13-14) and 0.5% of a surfactant (TUBIWASH SKP, available from CHT Group) were preheated to the desired detachment temperature. The release temperature was either 65 or 80° C. The flakes were stirred for 15 minutes in the hot washing solution with an anchor stirrer (5 cm diameter) at 350 revolutions per minute. After switching off the stirrer, cleaned PET flakes and flakes that have not been separated from the label sink to the bottom, BOPP label flakes float on the surface of the washing liquid. The BOPP label flakes are decanted off, and both fractions are rinsed with cold water and then dried at 110° C. in a drying cabinet. The removability is given as the percentage of flakes that have separated into cleaned PET and BOPP label film.

### Loop Tack Measurement

The loop tack measurements are carried out according to FINAT test method No. 9, but instead of glass, HDPE (high density polyethylene) is used as the test substrate. The label laminate is cut into strips 25 mm wide. To test, a strip is peeled off the siliconized paper release liner and a loop is formed with the adhesive side facing out. The loop is lowered onto the test substrate at 300 mm/min and pulled off again at 300 mm/min after complete contact. The maximum value of the force required to pull the loop off the test substrate is measured.

TABLE 2
Removability test results

| | Tackifier | Washing | | | | | |
|---|---|---|---|---|---|---|---|
| | Tg | temperature | removability [%] | | | | |
| Formulation | [° C.] | [° C.] | P1 | P2 | P3 | P4 | P5 |
| Without tackifier ^{x)} | — | 65 | 0 | 20 | 10 | 20 | 5 |
| T1 | −2 | 65 | 50 | 60 | 80 | 70 | 70 |
| T2 ^{x)} | 12 | 65 | 0 | 0 | 0 | 0 | 0 |
| T3 ^{x)} | 21 | 65 | 0 | 10 | 0 | 0 | 0 |
| T4 ^{x)} | 20 | 65 | — | — | — | 0 | — |
| T5 ^{x)} | 34 | 65 | 0 | 0 | 30 | 5 | 10 |

^{x)} comparative example

TABLE 3
Removability and loop tack test results

| | Washing | | Loop tack on |
|---|---|---|---|
| Example | temperature [° C.] | removability [%] | HDPE [N/25 mm] |
| P2/C ^{×)} | 65 | 30 | 3.0 |
| P2/C ^{x)} | 80 | 100 | |
| P4/T1/C | 65 | 80 | 2.8 |
| P4/T1/C | 80 | 100 | |

^{x)} comparative example

TABLE 4
Loop tack test results

| | Loop Tack on HDPE [N/25 mm] | | | | |
|---|---|---|---|---|---|
| Formulation | P1 | P2 | P3 | P4 | P5 |
| Without tackifier ^{x)} | 3.0 | 2.2 | 2.3 | 2.4 | 1.7 |
| T1 | 4.6 | 3.6 | 3.3 | 2.2 | 2.5 |
| T2 ^{x)} | 5.2 | 4.9 | 4.4 | 3.6 | 3.4 |
| T3 ^{x)} | 5.3 | 5.5 | 4.9 | 4.1 | 3.5 |
| T4 ^{x)} | — | — | — | — | — |
| T5 ^{x)} | 4.2 | 4.6 | 4.3 | 3.2 | 3.1 |

^{x)} comparative example

The test results show that high degrees of detachment can be achieved in short time and at low washing temperatures with the pressure-sensitive adhesive compositions according to the invention.

1.-19. (canceled)

20. An aqueous pressure-sensitive adhesive composition for recycling-compatible pressure-sensitive adhesive labels comprising
(A) a pressure-sensitive adhesive polymer dispersed in water with a glass transition temperature of −30° C. or less,
wherein the pressure-sensitive adhesive polymer is made by emulsion polymerization of
(a) from 70 to 99.5 wt. % of acrylic acid alkyl ester monomers with 2 to 12 carbon atoms in the alkyl group;
(b) at least 0.4 wt. % of at least one ethylenically unsaturated, copolymerizable monomer having at least one acid group;
(c) optionally one or more monomers selected from methyl acrylate, methyl methacrylate and methacrylic acid alkyl ester monomers with 2 to 12 carbon atoms in the alkyl group;
(d) optionally one or more ethylenically unsaturated monomers different from monomers (a), (b) and (c);
wt. % amounts of the monomers are based on the total weight amount of all monomers; and
(B) a tackifier with a glass transition temperature of less than 5° C.;
wherein the aqueous pressure-sensitive adhesive composition does not contain a water-dispersible halogen-free flame retardant in amounts of 15 to 45 weight parts, based on 100 parts of pressure-sensitive adhesive polymer in combination with a pressure-sensitive adhesive polymer made of 1 to 8 wt. % of phosphorous-containing monomers, based on the total weight amount of all monomers;
wherein the pressure-sensitive adhesive polymer has a second glass transition temperature of at least 0° C.; and
wherein glass transition temperatures are measured by differential scanning calorimetry according to ASTM D 3418-08 as the midpoint temperature when evaluating the second heating curve at a heating rate of 20° C./min.

21. Aqueous pressure-sensitive adhesive composition according to claim 20, wherein the composition is recycling-compatible to the extent that a pressure-sensitive adhesive label is detachable from polyethylene terephthalate articles to a degree of at least 50% according to the detaching test at 65° C. described in the examples.

22. Aqueous pressure-sensitive adhesive composition according to claim 20, wherein the tackifier (B) is used in amounts of from 5 to 100 parts by weight per 100 parts by weight of pressure-sensitive adhesive polymer based on solids, and is selected from rosin esters, terpene resins and their mixtures.

23. Aqueous pressure-sensitive adhesive composition according to claim 20, wherein the acrylic acid alkyl ester monomers (a) are used in an amount of from 75 to 99.5 wt. %, based on the total amount of monomers and are one or more selected from ethyl acrylate, propyl acrylate, n-butyl acrylate, isobutyl acrylate, 2-ethylhexyl acrylate, n-octyl acrylate, 2-octyl acrylate and isooctyl acrylate.

24. Aqueous pressure-sensitive adhesive composition according to claim 20, wherein the monomers (b) having at least one acid group are used in an amount of more than 1 and up to 4.5 wt. %, based on the total amount of monomers, and are one or more selected from acrylic acid, methacrylic acid, itaconic acid, maleic acid, fumaric acid, crotonic acid, vinylacetic acid, vinyllactic acid, vinylsulfonic acid, styrenesulfonic acid, acrylamidoglycolic acid, acrylamidomethylpropane sulfonic acid, sulfopropyl acrylate, sulfopropyl methacrylate, and their respective anhydrides.

25. Aqueous pressure-sensitive adhesive composition according to claim 20, wherein monomers (c) are used in amounts of from 0 to 20 wt. %, based on the total amount of monomers, and are methyl acrylate, methyl methacrylate or a mixture thereof.

26. Aqueous pressure-sensitive adhesive composition according to claim 20, wherein monomers (d) are used in amounts of from 0 to 20 wt. %, based on the total amount of monomers, and are selected from hydroxyalkyl (meth)acrylates having from 1 to 10 C atoms in the hydroxyalkyl group, vinyl esters of carboxylic acids comprising up to 20 C atoms, vinylaromatics having up to 20 C atoms, ethylenically unsaturated nitriles, amides of ethylenically unsaturated carboxylic acids, N-alkylolamides of ethylenically unsaturated carboxylic acids, phenyloxyethyl glycol mono(meth)acrylate, vinyl halides, vinyl ethers of alcohols comprising 1 to 10 C atoms, aliphatic hydrocarbons having 2 to 8 carbon atoms and one or two double bonds, ethylenically unsaturated monomers containing amino groups, bifunctional monomers which as well as an ethylenically unsaturated double bond have at least one glycidyl group, oxazoline group, ureido group, ureido-analogous group or carbonyl group, preferably diacetone acrylamide, and crosslinking monomers which have more than one free-radically polymerizable ethylenically unsaturated group, or mixtures of these monomers.

27. Aqueous pressure-sensitive adhesive composition according to claim 20, wherein the monomers (a) are used in an amount of 80 to 99.5 wt. % based on the total amount of monomers and are one or more selected from ethyl acrylate, propyl acrylate, n-butyl acrylate, isobutyl acrylate, 2-ethylhexyl acrylate, n-octyl acrylate, 2-octylacrylate and isooctyl acrylate; the monomers (b) having at least one acid group are used in an amount of more than 1 and up to 4.5 wt. %, based on the total amount of monomers, and are one or more selected from acrylic acid, methacrylic acid, itaconic acid and acrylamidomethylpropane sulfonic acid; monomers (c) are used in amounts of from 0 to 15 wt. %, based on the total amount of monomers, and are methyl acrylate, methyl methacrylate or a mixture thereof, and the monomers (d) are used in an amount of 0.1 to 10 wt. %, based on the total amount of the monomers, and are one or more selected from acrylamide and hydroxyalkyl (meth)acrylates having from 1 to 4 C atoms in the alkyl group.

28. Aqueous pressure-sensitive adhesive composition according to claim 20, wherein the loop tack of a dried film of the pressure-sensitive adhesive composition is at least 2 N/25 mm, measured as described in the examples.

29. Aqueous pressure-sensitive adhesive composition according to claim 20 comprising at least one crosslinking agent in an amount of 0.01 to 5 parts by weight, based on 100 parts by weight of aqueous pressure-sensitive adhesive polymer, selected from one or more of aminotriazines, isocyanurates formed from diisocyanates and having at least two isocyanate groups, compounds having at least one carbodiimide group, chemically capped isocyanates, encapsulated isocyanates, encapsulated uretdiones, biurets, allophanates, aziridines, oxazolines, and epoxides.

30. Aqueous pressure-sensitive adhesive composition according to claim 20, wherein the pressure-sensitive adhesive polymer is partly or completely made of partly or fully bio-based monomers.

31. Aqueous pressure-sensitive adhesive composition according to claim 20, wherein at least 50% of the monomers are partly or fully bio-based monomers and partly bio-based monomers are esters of (meth)acrylic acid and bio-based alcohols, preferably bio-based n-butanol, bio-based iso-butanol, bio-based iso-pentanol, bio-based 2-octanol or bio-based n-heptanol; and fully bio-based monomers are esters of bio-based acrylic acid and bio-based alcohols.

32. Adhesive label comprising a backing material having a first side and a second side, a pressure-sensitive adhesive layer attached to the first side of the backing material and either a release liner attached to the pressure-sensitive adhesive layer, or comprising a release-coating on the second side of the backing material,
wherein the backing material is made of polymeric film, paper or a polymeric film/paper laminate, and the pressure-sensitive adhesive layer is made from an aqueous pressure-sensitive adhesive composition according to claim 20.

33. The adhesive label according to claim 32, wherein the label is detachable from polyethylene terephthalate articles to a degree of at least 50% according to the detaching test at 65° C. as described in the examples.

34. The adhesive label according to claim 32, wherein the backing material is selected from polyolefins, wet-strength regenerated cellulose film and wet-strength paper, preferably biaxially oriented polypropylene.

35. Labelled packaging container comprising a packaging substrate and an adhesive label according to claim 32 attached to the surface of the packaging container, wherein the surface of the packaging container preferably is glass or plastic.

36. Method of recycling a labelled packaging container, the method comprising the steps of
(1) providing a labelled packaging container according to claim 35;
(2) shredding the labelled packaging container into smaller pieces;
(3) detaching label material from the shredded pieces by treating the shredded pieces with an aqueous washing composition;
(4) separating the shredded packaging material pieces from the detached label material and from the aqueous washing composition.

37. Method according to claim 36, wherein the aqueous washing composition comprises at least one surfactant, has pH in the range of from 10 to 14; and the washing temperature is 70° C. or below.

38. A method utilizing an aqueous pressure-sensitive adhesive composition according to claim 20
(a) for making a recycling-compatible adhesive labels; or
(b) for making a recycling-compatible packaging containers labelled with a recycling-compatible adhesive label; or
(c) in a method of recycling a labelled packaging container.
